(19) United States
(12) Patent Application Publication
(10) Pub. No.: US 2008/0010777 A1
(43) Pub. Date: Jan. 17, 2008

(54) Hinge damper in opening/closing device

(76) Inventors: Tsutomu Katsumata, Osaka-hu (JP); Takayuki Kaneko, Osaka-hu (JP)

Correspondence Address: NATH & ASSOCIATES, 112 South West Street, Alexandria, VA, 22314, US

(21) Appl. No.: 11/701,549

(22) Filed: Feb. 2, 2007

(30) Foreign Application Priority Data
Feb. 6, 2006 (JP) 2006-028157

(51) Int. Cl. E05F 3/20

(52) U.S. Cl. 16/63

(57) ABSTRACT

A hinge damper is comprised of a rotation axis that is rotated according to the rotation of a rotation member and is pivotally attached to a case to be able to rotate freely, a gearing that is attached to the rotation axis to be able to freely rotate while having an internal tooth, means for transferring the rotation of the open/close member to the gearing, a gear planet that is engaged with the internal tooth of the gearing, rotation control means that regulates the rotation of the gear planet so that its center performs circular locus movement around the rotation center of the gearing, and means that absorbs the rotation energy of the gearing.

### BACKGROUND OF THE INVENTION

1. Field of the Invention

The present invention relates to a hinge damper of an opening/closing device that enables smooth and safe opening/closing of an opening/closing member of a document pressing plate of a copier or an opening/closing member of a toilet seat.

2. Related Art

Conventionally, in an opening/closing device of a document pressing plate that includes an attachment member that is attached to an apparatus body such as a copier, a support member that can freely rotate and support the document pressing plate while being pivotally attached to the attachment member, and a compressed coil spring that is inserted between the attachment member and the support member while biasing the document pressing plate to the opening direction thereof, there is a technique that prevents the document pressing plate from suddenly falling because the weight of the document pressing plate overcomes the bias of the pressed coil spring and resultingly prevents a hand of the user from being caught between the plate and the apparatus body or the position of the document being moved (for example, refer to Patent Document 1).

However, the above-mentioned conventional technique to prevent the document pressing plate from sudden falling uses an oil damper and therefore has the following problems:
1. As the damper absorbs energy in the loading direction, rigidity is required for the case that receives a piston;
2. Since it is made of metal such as die-cast, the damper is heavy. In addition, since it becomes long in its axial direction, the damper requires space for installation;
3. To put it in a coil spring in a hinge, the spring itself is large-sized;
4. Since the oil viscosity resistance is converted into heat energy, it comes to possess high temperature when used continuously. Moreover, since the oil viscosity resistance depends on the outside temperature, it is unstable. Therefore, there may be cases where the damper does not function well when the opening/closing device is opened and closed in succession;
5. If the document pressing device is closed forcibly, overload is applied to the damper to raise the oil pressure inside thereof, which may lead to a damage;
6. Since the piston rod of the damper is prone to eccentric loading, it must be operated with high accuracy and may easily cause oil leakage and/or breakage of the device;
7. Oil or water around the damper may adhere on the piston rod, causing damage to a packing or malfunctioning;
8. When disposed, it requires an environmental measure due to oil or the like, and;
9. Since the oil depends on the outside temperature, when used in a location that is not kept in room temperature, performance of the damper differs significantly.
   Patent Reference 1: Japanese Utility Model Publication No. 2589714

The purpose of the present invention is to provide a hinge damper of an opening/closing device that can solve the above mentioned problems and is light weight, small, stable even when used for a long period of time, and easy to perform maintenance.

### SUMMARY OF THE INVENTION

A hinge damper of the present invention includes an attachment member to be attached to an apparatus body such as a copier, a support member that can freely rotate and support a open/close member such as a document pressing plate while being pivotally attached to the attachment member, a compressed coil spring that is inserted between the attachment member and the support member while biasing the open/close member toward its opening direction, and an elastic body such as urethane elastomer foam, wherein a rotation axis that is rotated according to the rotation of a rotation member and is pivotally attached to a case to be able to rotate, a gearing that is attached to the rotation axis while having internal teeth, means for transferring the rotation of the open/close member to the gearing, a gear planet that is engaged with the internal teeth of the gearing, rotation control means that regulates the rotation of the gear planet so that its center performs circular locus movement around the rotation center of the gearing, and means that absorb the rotation energy of the gearing are included. In addition, the means that transfers the rotation of the open/close member to the gearing is a sector gear. Moreover, the means that regulates the rotation of the gear planet has an actuation pin that is implanted in the gear planet and a bush that has a hole to which the actuation pin is inserted so that the action of the pin is regulated. Furthermore, the means to absorb the rotation energy of the gearing has a friction tooth formed on the gearing and a plate planet having wave-shape periphery surface on which the friction tooth slides. Still furthermore, the hinge damper is incorporated into the attachment member of the open/close member.

The hinge damper of the present invention has following advantages; it has a large capacity to absorb energy thanks to the structure of a small damper function, is light weight and small, stable when used for a long period of time, and is easy to perform maintenance. Moreover, there is another advantage that as it does not use oil like conventional oil dampers, problems mentioned above can be avoided.

### BRIEF DESCRIPTION OF THE DRAWINGS

FIG. 1A is a side-view of an opening/closing device of a document pressing plate having a hinge damper of the present invention and 1B is a view showing its function.

FIG. 2 is an external view of the hinge damper.

FIG. 3 is a perspective view of a hinge damper that is disassembled in a support axis direction.

FIG. 4 is a cross sectional view of the hinge damper.

FIG. 5 is a cross sectional view taken along a line A-A of FIG. 4.

FIG. 6 is a cross sectional view taken along a line B-B of FIG. 4.

### DESCRIPTION OF THE PREFERRED EMBODIMENTS

Hereinafter, an embodiment of a hinge damper of an opening/closing device of the present invention will be described referring to figures.

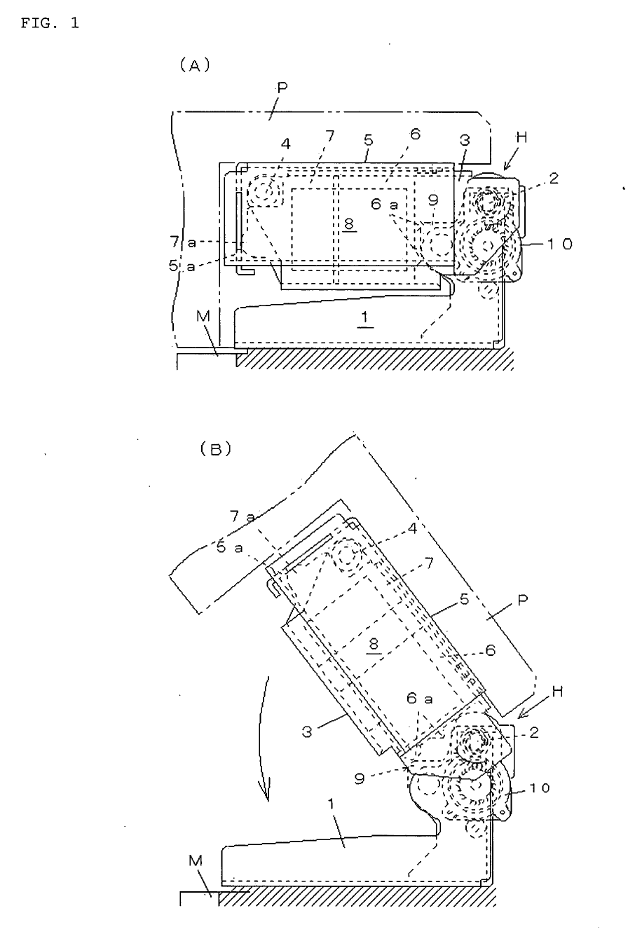

In FIG. 1, P is a document pressing plate which is attached to M, a main body of a copier or the like, via an H, which is an opening/closing device. P can open/close freely. The opening/closing device H mainly includes an attachment member 1 which is attached to the main body M, a support arm 3 which is pivotally attached to the attachment member 1 via a hinge axis 2 so as to allow the support arm 3 to freely move in a rotational manner, and a lift arm 5 which is pivotally attached to a tip of the support arm 3 via a support axis 4 so as to allow the lift arm 5 to freely move in a rotational manner.

In the support arm 3, a first slider 6 and a second slider 7 are installed while enabling them to freely slide in a longitudinal direction. Between the first and second sliders 6 and 7, a compressed coil spring 8 is inserted. Instead of the compressed coil spring 8, an urethane elastomer foam may be used. A cam follower 6a of the first slider 6 is attached to a cam part 9 placed on the attachment member 1, while a cam follower 7a of the second slider 7 is attached to a front side plate 5a of the lift arm 5. Note that the opening/closing device H of the present invention is not limited to the structure described above and any conventional structure, for example, one in which the support axis 4 and the lift arm 5 are not included and the document pressing plate P is attached and fixed to the support arm 3, may be used.

In the attachment member 1 which is in the vicinity of the hinge axis 2, a case 10 of the hinge damper is provided.

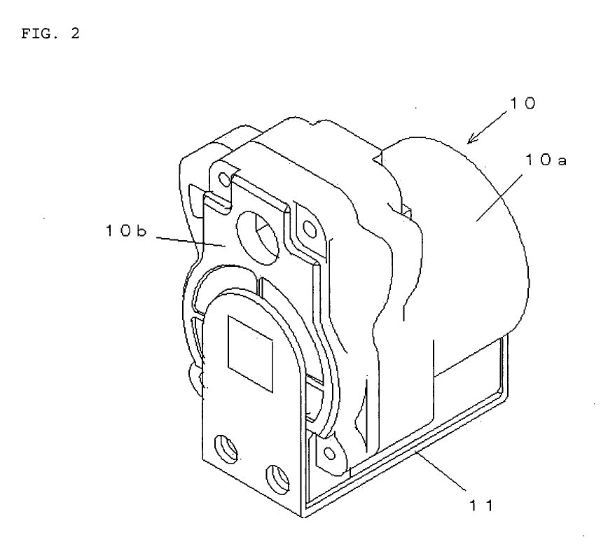

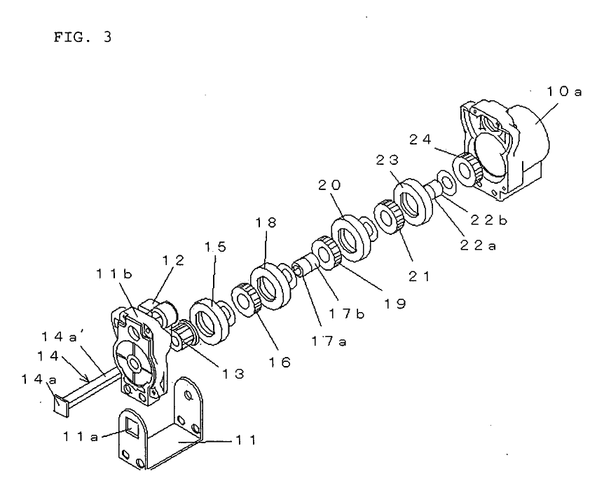

FIG. 2 shows external appearance of the case 10 of the hinge damper and the case 10 includes a case body 10a and a lid 10b. 11 is an attachment frame for attaching the case 10 to the opening/closing device H. In the case 10, as shown in FIG. 3 which is an exploded diagram, a hinge damper is installed.

In FIG. 3, 12 is a sector gear, 13 is a small gear, 14 is a support axis, 15 is a first internal tooth gear, 16 is a first gear planet, 17a is a first eccentric shaft, 17b is a second eccentric shaft, 18 is a second internal tooth gear, 19 is a second gear planet, 20 is a third internal tooth gear, 21 is a third gear planet, 22a is a third eccentric shaft, 22b is a fourth eccentric shaft, 23 is a fourth internal tooth gear, and 24 is a fourth gear planet.

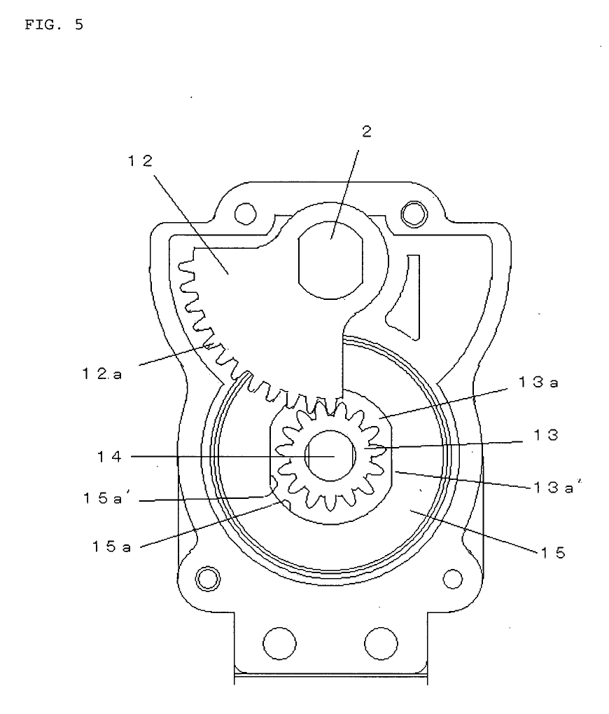

As apparent from FIG. 5, the sector gear 12 is attached and fixed to the hinge axis 2 of the opening/closing device H and rotates along with the rotation of the hinge axis 2. On the sector gear 12, along the rotation angle thereof that is almost equal to the rotation angle of the opening/closing device H, teeth 12a are formed.

The small gear 13 is attached to freely rotate around the support axis 14 and is engaged with the sector gear 12. A flange portion 13a is provided to the small gear 13 in an integrated manner. The flange portion 13a has a plain part 13a′. On the tip of the support axis 14, a square-headed bolt 14a is provided and is fitted into a square hole 11a of the attachment frame 11 to prevent it from rotating.

As apparent from FIG. 5, the flange portion 13a of the small gear 13 is fitted into a hole 15a formed on the first internal tooth gear 15 and a plain part 15a′ thereof is attached to the plain part 13a′ of the flange portion 13 so that they are rotated in an integrated manner.

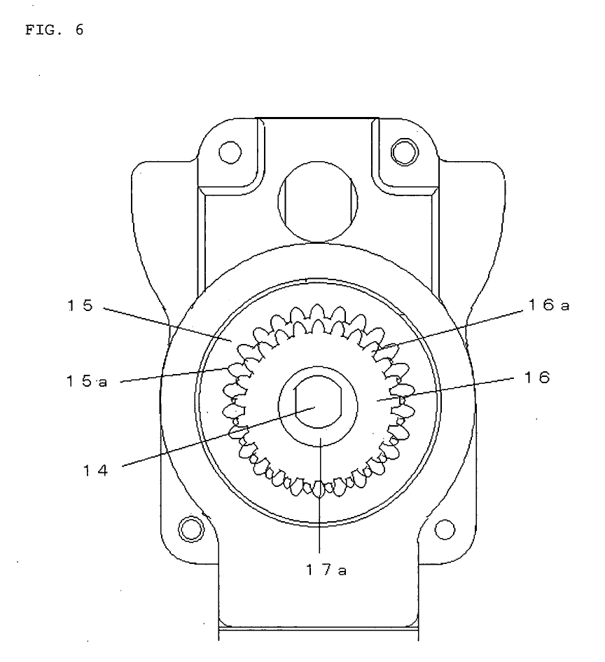

As shown in FIG. 6, teeth 16a of the first gear planet 16 is engaged with teeth 15a of the first internal tooth gear 15 and can roll. The first gear planet 16 is attached to the first eccentric shaft 17a and can freely rotate. The first eccentric shaft 17a is attached to the support axis 14 and cannot rotate. Therefore, the first gear planet 16 rotates in a condition where it is decentered to the central axis of the support axis 14.

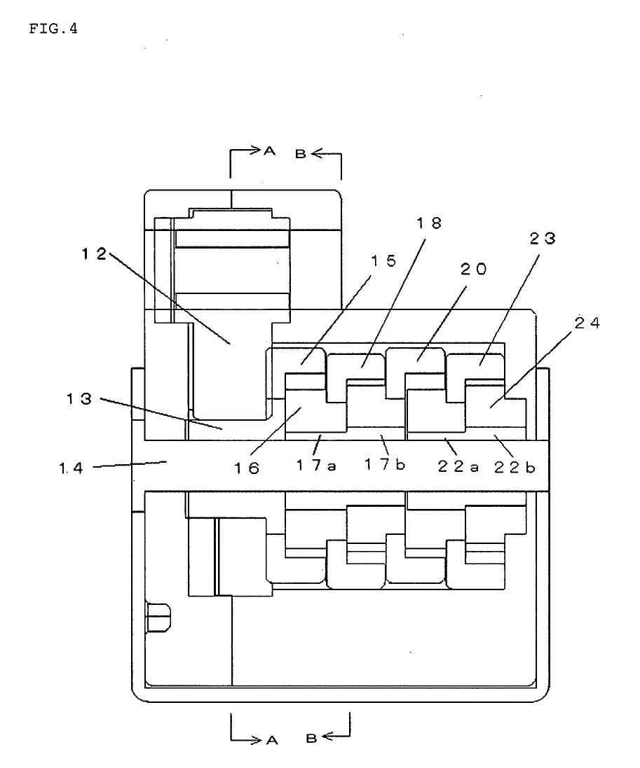

As apparent from FIG. 4, the second internal tooth gear 18 is connected to the first gear planet 16 so that they rotate in an integrated manner. The second internal tooth gear 18 is engaged with the second gear planet 19 so that they rotate in an integrated manner. The second gear planet 19 is attached so that it rotates in a condition where it is decentered to the second eccentric shaft 17b. The first eccentric shaft 17a and the second eccentric shaft 17b are located to be symmetric to the central axis of the support axis 14.

The third internal tooth gear 20 is connected to the second gear planet 19 so that they can rotate in an integrated manner. The third gear planet 21 is engaged with the third internal tooth gear 20 so that they can rotate in an integrated manner. The third gear planet 21 is attached so that it rotates in a condition where it is decentered to the third eccentric shaft 22a.

The fourth internal tooth gear 23 is connected to the third gear planet 26 so that they can rotate in an integrated manner. The fourth internal tooth gear 23 is engaged with the fourth gear planet 24 so that they can rotate in an integrated manner. The fourth gear planet 24 is attached so that it rotates in a condition where it is decentered to the fourth eccentric shaft 22b. The third eccentric shaft 22a and the fourth eccentric shaft 22b are located to be symmetric to the central axis of the support axis 14.

Because the hinge damper of the present embodiment is structured as above, when the document pressing plate P is closed as in FIG. 1 (B) to the arrow direction, the sector gear 12 integrated with the hinge axis 2 is rotated counterclockwise, as indicated by an arrow in FIG. 2, and turns the small gear 13 clockwise.

When the small gear 13 rotates, together with this movement, the first internal tooth gear 15 rotates and the first gear planet 16 that is engaged with the internal tooth gear 15 rotates in the same direction. The number of teeth N of the first internal tooth gear 15 is more than the number of teeth of the first gear planet 16 n (N>n). Therefore, when the first internal tooth gear 15 is rotated 360°, speed of the first gear planet 16 is increased for the N/n times of rotation.

The rotation of the first gear planet 16 also increases the speed of the second gear planet 19 via the second internal tooth gear 18. Thus, the speed of the third gear planet 21 and the fourth gear planer 24 are increased sequentially.

Due to the engagement friction (resistance) of each internal gear and gear planet, the rotation energy is absorbed.

Means to transfer the rotation of the opening/closing device H is not limited to the above mentioned sector gear or other kind of gear and a power transmission mechanism such as a belt or a link may be used.

The opening/closing device of the hinge damper of the present invention is not limited to the above mentioned document pressing plate of a copier, but is applicable to hinge that opens/closes an open/close member of a scanner, a fax, or a lid of a toilet seat.

What is claimed is:

1. A hinge damper of an opening/closing device comprising:
an attachment member attached to an apparatus body such as a copier, a support member that can freely rotate and support a open/close member such as a document pressing plate while being pivotally attached to the attachment member,
a compressed coil spring that is inserted between the attachment member and the support member while biasing the open/close member toward its opening direction, and
an elastic body such as an urethane elastomer foam, wherein a rotation axis that is rotated according to the rotation of a rotation member and is pivotally attached to a case to be able to rotate, a gearing that is attached to the rotation axis while having an internal tooth, means for transferring the rotation of the open/close member to the gearing, a gear planet that is engaged with the internal tooth of the gearing, rotation control means that regulates the rotation of the gear planet so that its center performs circular locus movement around the rotation center of the gearing, and means that absorb the rotation energy of the gearing are included.

2. The hinge damper of an opening/closing device according to claim 1, wherein the means that transfers the rotation of the open/close member to the gearing is a sector gear.

3. The hinge damper of an opening/closing device as claimed in claim 2, wherein the means that regulates the rotation of the gear planet includes an actuation pin that is implanted in the gear planet and a bush that has a hole to which the actuation pin is inserted so that the action of the pin is regulated.

4. The hinge damper of an opening/closing device as claimed in claim 3, wherein the means to absorb the rotation energy of the gearing has a friction tooth formed on the gearing and a plate planet having wave-shape periphery surface on which the friction tooth slides.

5. The hinge damper as claimed in claim 4, wherein the hinge damper is incorporated into the attachment member of the open/close member.

6. The hinge damper as claimed in claim 3, wherein the hinge damper is incorporated into the attachment member of the open/close member.

7. The hinge damper of an opening/closing device as claimed in claim 2, wherein the means to absorb the rotation energy of the gearing has a friction tooth formed on the gearing and a plate planet having wave-shape periphery surface on which the friction tooth slides.

8. The hinge damper as claimed in claim 7, wherein the hinge damper is incorporated into the attachment member of the open/close member.

9. The hinge damper of an opening/closing device as claimed in claim 1, wherein the means that regulates the rotation of the gear planet includes an actuation pin that is implanted in the gear planet and a bush that has a hole to which the actuation pin is inserted so that the action of the pin is regulated.

10. The hinge damper of an opening/closing device as claimed in claim 1, wherein the means to absorb the rotation energy of the gearing has a friction tooth formed on the gearing and a plate planet having wave-shape periphery surface on which the friction tooth slides.

11. The hinge damper as claimed in claim 1, wherein the hinge damper is incorporated into the attachment member of the open/close member.
